(19) United States
(12) Patent Application Publication
(10) Pub. No.: US 2002/0159255 A1
(43) Pub. Date: Oct. 31, 2002

(54) Flashlight

(76) Inventor: Chin Hsiang Chen, Tainan (TW)

Correspondence Address: PRO-TECHTOR INTERNATIONAL, 20775 Norada Court, Saratoga, CA, 95070-3018, US

(21) Appl. No.: 09/844,901

(22) Filed: Apr. 26, 2001

(51) Int. Cl. F21L 4/04

(52) U.S. Cl. 362/206; 200/345

(57) ABSTRACT

A press-button type switch mechanism is provided in a flashlight and controlled to switch on/off the circuit of the lamp bulb and the battery set, the switch mechanism including an electrically insulative holder shell supported on a metal spring at one end of the battery set, a base block received in a rear receiving space of the holder shell, the base block having two lead-legs inserted through respective through holes on the holder shell and connected to the metal spring, a metal contact plate disposed at one side in close contact with the inside wall of a metal rear end cap, and an actuating rod, and a button extended out of the rear end cap and supported on a spring at the actuating rod for operation by hand to move the actuating rod in closing/opening the circuit between the metal contact plate and the lead-legs.

### BACKGROUND OF THE INVENTION

The present invention relates to a flashlight and, more specifically, to a switch mechanism for flashlight, which is easy to install and, can be positively operative to switch on/off the lamp bulb of the flashlight.

FIGS. from 1 through 3 show a known structure of flashlight, which is an invention of the present inventor and patented in Taiwan under Utility model no. 411992. This structure of flashlight is functional, however it still has drawbacks. According to this design, the switch mechanism of the flashlight comprises a base block a, a front metal contact plate b2 disposed at the front side of the base block a and connected to the negative terminal of the battery set, a side metal contact plate b1 disposed at one side of the base block a and riveted to the metal rear end cap c. This design of switch mechanism is complicated. During installation, the front metal contact plate 2 tends to be damaged.

### SUMMARY OF THE INVENTION

It is one object of the present invention to provide a flashlight, which has a simple structure of switch mechanism for on/off control. It is another object of the present invention to provide a switch mechanism for a flashlight, which is easy to install. The flashlight according to the present invention comprises A flashlight comprising a metal barrel having a front end and a rear end, a metal rear end cap fastened to the rear end of the metal barrel, the metal rear end cap having a rear center through hole, a metal front spring mounted in the front end of the metal barrel, a lamp bulb supported on the metal front spring in the front end of the metal barrel, the lamp bulb having a ring contact connected to the metal front spring and a tip contact, a battery set mounted in the metal barrel, the battery set having a positive terminal connected to the tip contact of the lamp bulb and a negative terminal, and a switch mechanism mounted in the metal barrel and connected to the negative terminal of the battery set and controlled to switch on/off the circuit of the lamp bulb and the battery set. The switch mechanism comprises an electrically insulative holder shell mounted in the metal barrel, the holder shell comprising two axially extended through holes, a front annular groove disposed in communication with the axially extended through holes, and a rear receiving space; a first metal spring mounted in the front annular groove of the electrically insulative holder shell and connected to the negative terminal of the battery set; a base block mounted in the rear receiving space of the electrically insulative holder shell, the base block comprising two lead-legs forwardly extended out of a bottom side thereof and respectively inserted into the through holes of the electrically insulative holder shell, a metal contact plate disposed at one lateral side thereof and maintained in contact with an inside wall of the metal rear end cap, and an actuating rod controlled to close/open the circuit between the lead-legs and the metal contact plate so as to further close/open the circuit of the lamp bulb and the battery set; a second metal spring mounted on the base block and connected to the actuating rod; and a button supported on the second metal spring and extended out of the rear center through hole of the metal rear end cap for operation by hand to move the actuating rod and to close/open the circuit between the lead-legs and the metal contact plate.

### BRIEF DESCRIPTION OF THE DRAWINGS

FIG. 1 is an exploded view of a flashlight constructed according to the prior art.

FIG. 2 is a sectional assembly view of the prior art flashlight.

FIG. 3 is a cutaway in an enlarged scale of a part of the prior art flashlight.

FIG. 4 is an exploded view of the preferred embodiment of the present invention.

FIG. 5 is a sectional assembly view of the preferred embodiment of the present invention, showing the switch mechanism switched off.

FIG. 6 is similar to FIG. 5 but showing the switch mechanism switched on.

FIG. 7 is a sectional view in an enlarged scale taken along line A-A′ of FIG. 5.

FIG. 8 is a schematic drawing showing the clip turned about the rear end cap of the flashlight according to the present invention.

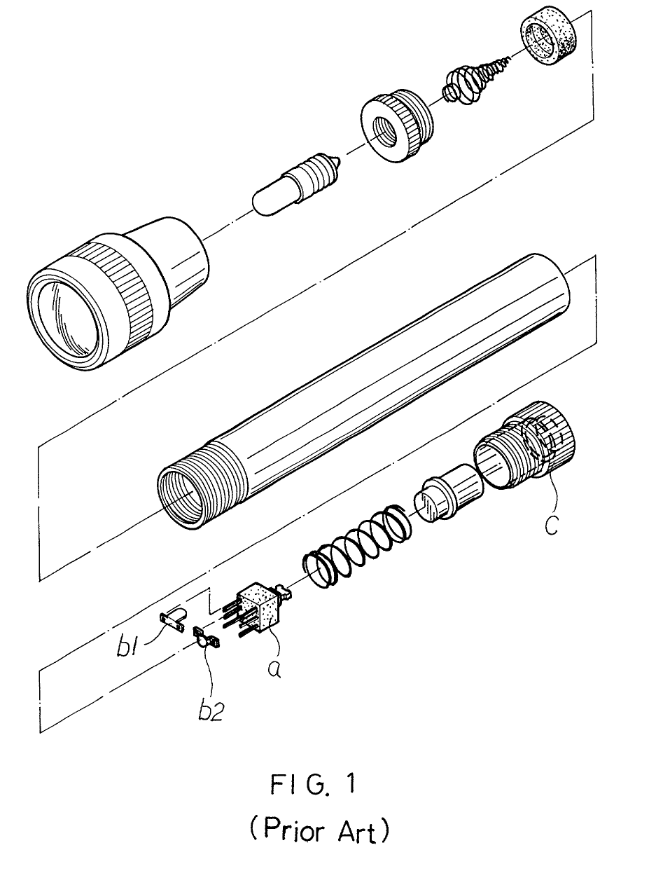

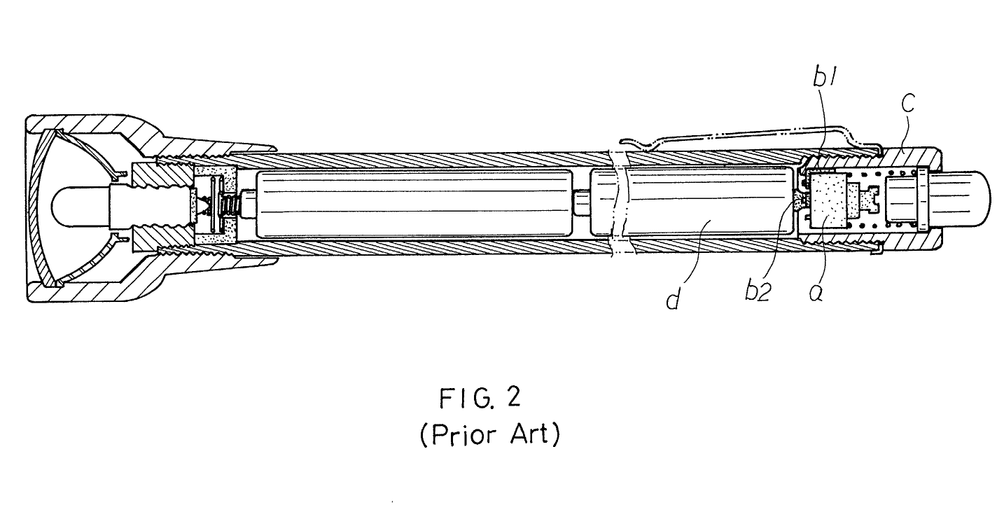

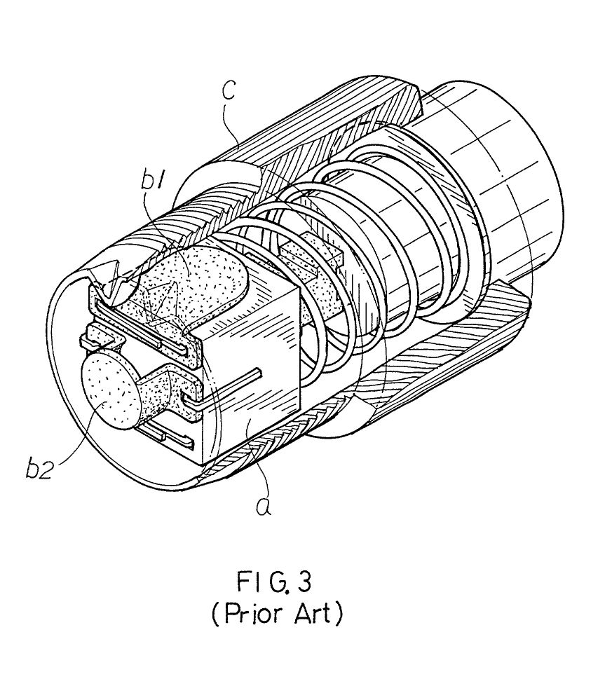

### DETAILED DESCRIPTION OF THE PREFERRED EMBODIMENT

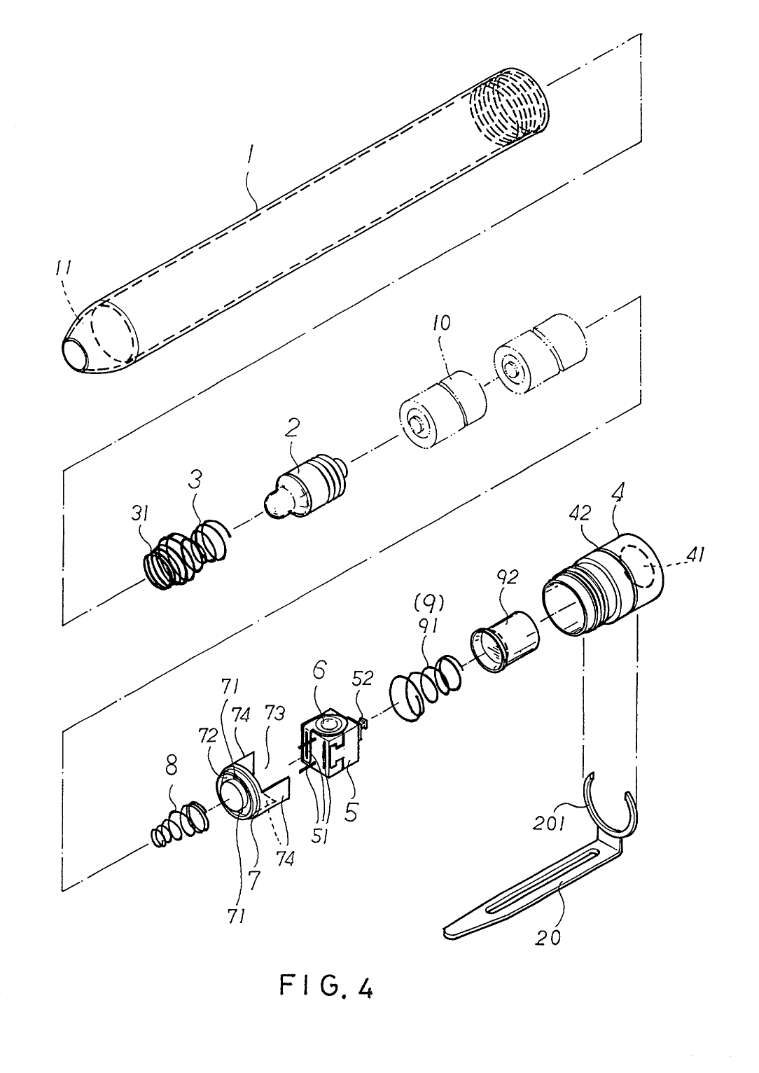

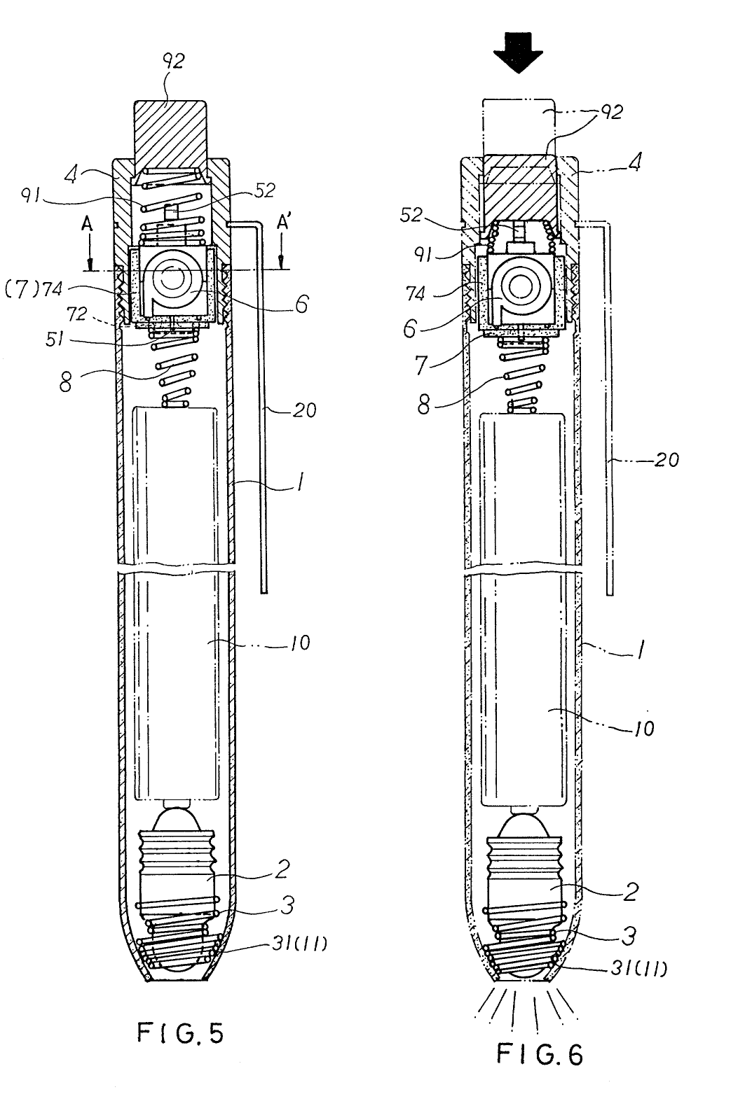

Referring to FIGS. 4 and 5, a flashlight in accordance with the present invention is shown comprising a metal barrel 1, the metal barrel 1 having a tapered front end 11, a metal spring 3 mounted inside the tapered front end 11 of the metal barrel 1, the metal spring 3 having a conical front side 31 fitting the conical inside wall of the tapered front end 11 of the metal barrel 1, a lamp bulb 2 mounted in the metal barrel 1 and supported with its ring contact on the metal spring 3, a metal rear end cap 4 fastened to the rear end of the metal barrel 1, the metal rear end cap 4 having a rear center through hole 41, a set of battery cells 10 mounted in the metal barrel 1, and a switch mechanism installed in the metal barrel 1 and the metal rear end cap 4 and controlled to turn on/off the lamp bulb 2. The front end 11 of the metal barrel 1 and the front end 31 of the metal spring 3 preferably have an arched cross section. The switch mechanism is comprised of a base block 5, a metal contact plate 6, a holder shell 7, a conical metal spring 8, and a control button assembly 9.

The base block 5 comprises three pairs of legs 51 and an actuating rod 52. One pair of the legs 51 are bent inwards and closely attached to the bottom sidewall of the base block 5. A second pair of the legs 51 is perpendicularly extended from the bottom sidewall of the base block 5. A third pair of the legs 51 is provided at one lateral side of the base block 5 and adapted to hold down the metal contact plate 6 (see FIG. 4).

The metal contact plate 6 is fastened to one lateral side of the base block 5 and secured in place by one pair of the legs 51 (see FIGS. 4, 5 and 6).

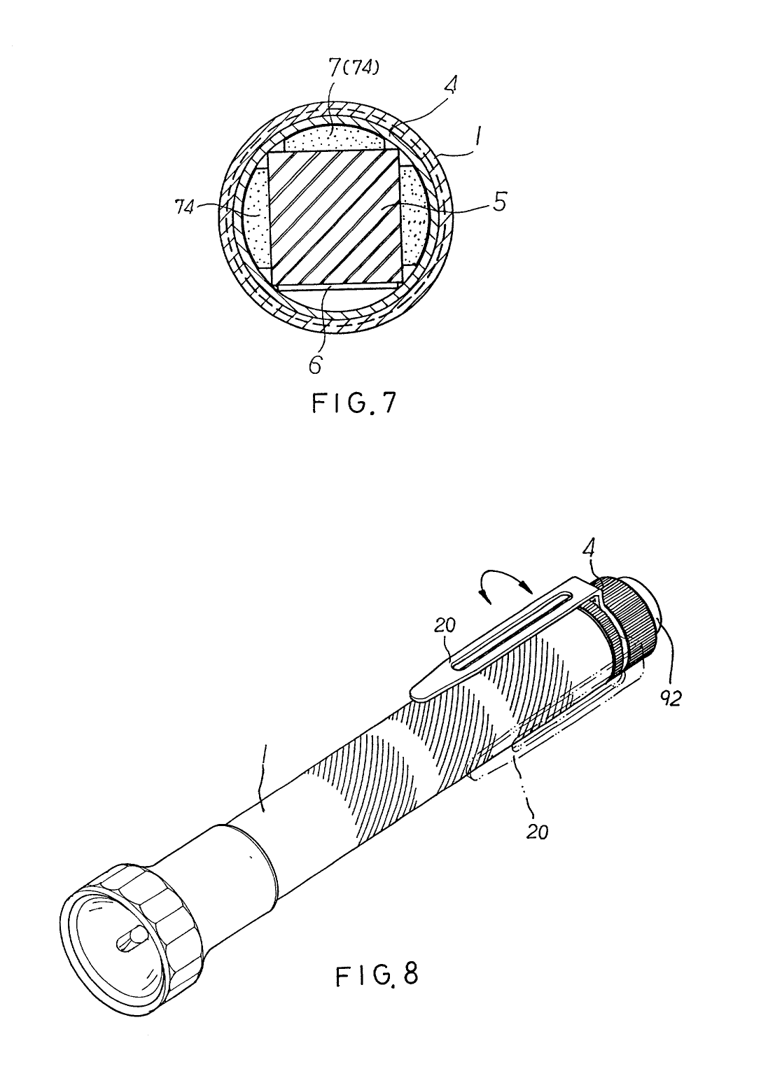

The holder shell 7 is an electrically insulative shell injection-molded from plastics and supported in the metal barrel 1 between the base block 5 and the conical metal spring 8, comprising two axially extended through holes 71, which receives the forwardly extended bottom pair of the legs 51 of the base block 5, a front annular groove 72 disposed in communication with the through holes 71 and adapted to receive one end of the conical metal spring 8, three backward strips 74 respectively inserted into the metal rear end cap 4, and a rear receiving space 73 surrounded by the backward strips 74 and adapted to receive the base block 5 for enabling the metal contact plate 6 to be maintained in close contact with the inside wall of the metal rear end cap 4 (see FIG. 7).

The conical metal spring 8 has a big rear end engaged into the front annular groove 72 of the holder shell 7 and a small front end stopped against the negative terminal of the battery set 10, which has its positive terminal stopped against the tip contact of the lamp bulb 2 (see FIGS. 5 and 6).

The control button assembly 9 comprises a spring member 91 fastened to the actuating rod 52 of the base block 5, and a button 92 supported on the spring member 91 and extended out of the rear center through hole 41 of the rear end cap 4 (see FIGS. 5 and 6).

Further, the rear end cap 4 has a coupling groove 42 disposed around the periphery, and a clip 20 is fastened to the coupling groove 42 of the rear end cap 4 (see FIGS. 4 and 8). The clip 20 comprises a C-shaped clamping head 201 coupled to the coupling groove 42. When installed, the clip 20 can be turned about the rear end cap 4 (see FIG. 8). Further, the rear end cap 4 has an inner diameter made gradually smaller toward the rear center through hole 41 so that the base block 5 can be positively positioned in the rear end cap 4 to hold the metal contact plate 6 in close contact with the inside wall of the rear end cap 4.

When pressing on the button 92 to force down the actuating rod 52 of the base block 5, the switch mechanism is switched on to close the circuit, and therefore the battery set 10 is electrically connected to the lamp bulb 2, causing the lamp bulb 2 to emit light. On the contrary, when pressing off the button 92 to release the actuating rod 52 of the base block 5, the switch mechanism is switched off to open the circuit, and therefore the battery set 10 is electrically disconnected from the lamp bulb 2, and the lamp bulb 2 is turned off.

A prototype of flashlight has been constructed with the features of FIGS. 4˜8. The flashlight functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A flashlight comprising a metal barrel having a front end and a rear end, a metal rear end cap fastened to the rear end of said metal barrel, said metal rear end cap having a rear center through hole, a metal front spring mounted in the front end of said metal barrel, a lamp bulb supported on said metal front spring in the front end of said metal barrel, said lamp bulb having a ring contact connected to said metal front spring and a tip contact, a battery set mounted in said metal barrel, said battery set having a positive terminal connected to the tip contact of said lamp bulb and a negative terminal, and a switch mechanism mounted in said metal barrel and connected to the negative terminal of said battery set and controlled to switch on/off the circuit of said lamp bulb and said battery set, wherein said switch mechanism comprises:
an electrically insulative holder shell mounted in said metal barrel, said holder shell comprising two axially extended through holes, a front annular groove disposed in communication with said axially extended through holes, and a rear receiving space;
a first metal spring mounted in the front annular groove of said electrically insulative holder shell and connected to the negative terminal of said battery set;
a base block mounted in said rear receiving space of said electrically insulative holder shell, said base block comprising two lead-legs forwardly extended out of a bottom side thereof and respectively inserted into the through holes of said electrically insulative holder shell and connected to said first metal spring, a metal contact plate disposed at one lateral side thereof and maintained in contact with an inside wall of said metal rear end cap, and an actuating rod controlled to close/open the circuit between said lead-legs and said metal contact plate so as to further close/open the circuit of said lamp bulb and said battery set;
a second metal spring mounted on said base block and connected to said actuating rod; and
a button supported on said second metal spring and extended out of the rear center through hole of said metal rear end cap for operation by hand to move said actuating rod and to close/open the circuit between said lead-legs and said metal contact plate.

2. The flashlight of claim 1 wherein said electrically insulative base block comprises three backward strips surrounding said rear receiving space and adapted to hold said base block in said rear receiving space.

3. The flashlight of claim 1 wherein said metal rear end cap comprises a coupling groove disposed around the periphery thereof and a clip coupled to said coupling groove.

4. The flashlight of claim 1 wherein the front end of said metal barrel has a tapered inside wall.

5. The flashlight of claim 4 wherein said metal front spring has a conical front end fitting the tapered inside wall of the front end of said metal barrel.

6. The flashlight of claim 5 wherein the front end of said metal barrel and the front end of said metal front spring has an arched cross section.

7. The flashlight of claim 1 wherein said rear end cap has an inner diameter gradually smaller toward said rear center through hole.
